(19) United States
(12) Patent Application Publication
(10) Pub. No.: US 2024/0036939 A1
(43) Pub. Date: Feb. 1, 2024

(54) DETERMINISTIC EXECUTION OF BACKGROUND JOBS IN A LOAD-BALANCED SYSTEM

(71) Applicant: SAP SE, Walldorf (DE)

(72) Inventors: Alexander Ocher, San Jose, CA (US); Sreenivasulu Gelle, San Ramon, CA (US)

(21) Appl. No.: 18/176,352

(22) Filed: Feb. 28, 2023

Related U.S. Application Data
(60) Provisional application No. 63/393,006, filed on Jul. 28, 2022.

(51) Int. Cl. G06F 9/50

(52) U.S. Cl. CPC G06F 9/5083; G06F 9/505

(57) ABSTRACT

Disclosed herein are system, method, and computer program product embodiments for performing deterministic execution of background jobs in a load-balanced system. An embodiment operates by receiving, at a work server in a load-balanced system, job submission code from a client connected to the work server, wherein the job submission code performs a background job for the client. The embodiment then executes, at the work server, the job submission code. The execution of the job submission code obtains a name of the work server executing the job submission code, maps the name of the work server to a logical server name, and submits the background job for background processing using a job processing function that executes the background job on the logical server name.

### CROSS-REFERENCE TO RELATED APPLICATIONS

This application claims the benefit and priority to U.S. Provisional Patent Application No. 63/393,006, filed Jul. 28, 2022, entitled “Deterministic Execution of Background Jobs on a Load-Balanced System,” which is incorporated herein by reference in its entirety.

### BACKGROUND

When a client connects to a load-balanced system, the connection may be made to one of the work servers (e.g., an application server) in the system based on load balancing criteria. For example, the connection may be made to one of the work servers according to a round robin schedule, system load of the work server, response time of the work server, or other criteria as would be appreciated by a person of ordinary skill in the art. However, if the client wants to submit a job (e.g., a background job) to the work server in the load-balanced system, disconnect, and, when the job is complete, connect to the same work server, this is often not possible. Moreover, it is often not possible for the job to connect back to the client and send its results to the client.

### BRIEF DESCRIPTION OF THE DRAWINGS

The accompanying drawings are incorporated herein and form a part of the specification.

FIG. 1 is a block diagram of a load-balanced system that includes deterministic execution of background jobs, according to some embodiments.

FIG. 2 is a flowchart illustrating a process for performing deterministic execution of background jobs on a load-balanced system, according to some embodiments.

FIG. 3 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for performing deterministic execution of jobs (e.g., background jobs) in a load-balanced system. This solves the technological problem associated with a client connecting to a random work server in a load-balanced system and executing a job on yet another random work server.

More specifically, when a client connects to a load-balanced system, the connection may be made to one of the work servers (e.g., an application server) in the system based on load balancing criteria. For example, the connection may be made to one of the work servers according to a round robin schedule, system load of the work server, response time of the work server, or other criteria as would be appreciated by a person of ordinary skill in the art. However, if the client wants to submit a job (e.g., a background job) to the work server in the load-balanced system, disconnect, and, when the job is complete, connect to the same work server, this is often not possible. Moreover, it is often not possible for the job to connect back to the client and send its results to the client. These technological problems often occur because the job may be scheduled on a different work server than the client initially connected to in order to optimize overall processing in the load-balanced system (e.g., response time, uneven overloading, or availability).

To submit a job to a work server, a client may submit job submission code to the load-balanced system for execution by the work server. The job submission code may instruct a work server to perform the job. The job submission code may include a command such as “submit program,” where “program” represents the job that the work server is to perform. However, if the client wants to submit the job to a work server, disconnect from the work server, and, when the job is complete, connect to the same work server, this is often not possible. This is because the client is unsure which work server in the load-balanced system is actually executing the job. To avoid these technological problems, a client may connect to a specific work server. For example, the client may submit a job to a specific work server (e.g., “first work server”). To submit a job to a specific work server, the client may transmit job submission code to the load-balanced system such that the job submission code includes a command such as “submit program on first work server,” where “program” represents the job to perform and “first work server” indicates the job is to be executed on “first work server.” By hardcoding the specific work server (e.g., “first work server”) in the job submission code, the client can ensure that the job only executes on the specific work server (e.g., “first work server”). However, this approach can lose the advantages of load balancing, such as, but not limited to, ensuring the job runs on a working server (e.g., high availability) or choosing the least loaded work server.

Alternatively, to avoid these technological problems, the client can provide specific host/port information in remote function call (RFC) destination settings to the work server. As a result, when the client submits a job (e.g., a background job), closes the original connection, and waits for the job completion, it can listen on the connection gateway of the work server for a callback. However, this would also lose the benefits of load-balancing. Thus, what is needed are system, apparatus, device, method and/or computer program product embodiments for executing a job on a load-balanced system so that the client can connect to the proper work server, submit a background job, and, when the job is complete, connect to the same work server to read the job results.

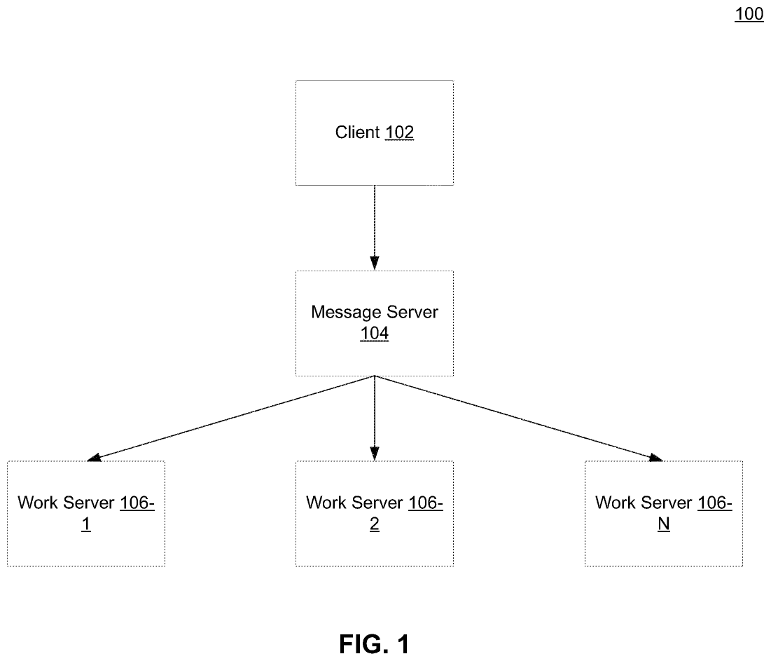

FIG. 1 is a block diagram of a load-balanced system 100 that includes deterministic execution of background jobs, according to some embodiments. System 100 can include client 102, message server 104, and one or more work servers 106.

Client 102 can be a desktop computer, laptop, tablet, smartphone, server, cloud computing system, computer cluster, virtual machine, container, or other device as would be appreciated by a person of ordinary skill in the art. Client 102 can also be a software-implemented system.

Message server 104 can be server, cloud computing system, computer cluster, virtual machine, container, desktop computer, laptop, tablet, smartphone, or other device as would be appreciated by a person of ordinary skill in the art. Message server 104 can distribute a set of jobs (or tasks) over a set of resources (e.g., work servers 106), with the aim of making their overall processing more efficient. Message server 104 can optimize the response time and avoid unevenly overloading some work servers 106 while other work servers 106 are left idle. Message server 104 may also be referred to as a load balancer.

Work server 106 can be a server, cloud computing system, computer cluster, virtual machine, container (e.g., Kubernetes), or other device in a load-balanced system (e.g., load-balanced system 100). Work server 106 can be an application server. An application server can host applications or software that delivers an application through a communication protocol to a system (e.g., client 102).

As shown in FIG. 1, client 102 may be communicatively coupled to message server 104. For example, client 102 may communicate with message server 104 over a communications path, which may be wired and/or wireless (or a combination thereof), and which may include any combination of LANs, WANs, the Internet, etc. Control logic and/or data may be transmitted to and from message server 104 via the communication path.

Client 102 may also be communicatively coupled to one or more work servers 106. For example, client 102 may communicate with a work server 106 over a communications path, which may be wired and/or wireless (or a combination thereof), and which may include any combination of LANs, WANs, the Internet, etc. Control logic and/or data may be transmitted to and from the work server 106 via the communication path.

To execute a job (e.g., a background task or unit of execution) in load-balanced system 100 without losing the benefits of load-balancing, client 102 may trigger a process that deterministically executes the job on a particular work server 106 in load-balanced system 100.

Initially, client 102 can make a connection to message server 104. When client 102 makes the connection to message server 104, client 102 can determine the name of the particular work server 106 that it ends up being connected to by message server 104. Client 102 may represent its connection to the particular work server 106 using a connection object. Client 102 can determine the name of the work server 106 that it is connected to by reading the name of the work server 106 from attributes of the connection object. For example, client 102 can determine the name of the work server 106 that it is connected to by reading the name of the work server 106 from the RFC_ATTRIBUTES in the connection object. As would be appreciated by a person of ordinary skill in the art, client 102 can determine the name of the work server 106 that it is connected to in various other ways using the connection object.

Client 102 can also determine the name of the work server 106 that it is connected to by calling a remote function at the work server 106. For example, client 102 can determine the name of the work server 106 that it is connected to by calling the RFC_SYSTEM_INFO function at the work server 106. Client 102 may determine the name of the work server 106 that it is connected to by calling the remote function at the work server 106 if it was unable to determine name of the work server 106 using its connection object. Client 102 can determine the name of the work server 106 that it is connected to using various other mechanisms as would be appreciated by a person of ordinary skill in the art.

Once client 102 determines the name of the work server 106 (e.g., possibly prepended with a routing string), client 102 can check if a new connection can be directly opened to the work server 106. If a connection cannot be opened successfully, client 102 can generate a name using the name of the work server 106 and the fully qualified domain name (FQDN) of message server 104. For example, client 102 can append a domain name portion of the FQDN of message server 104 to the name of the work server 106. Client 102 can then open a connection to the work server 106 using the generated name. For example, if the FQDN of message server 104 is acmems01.wdf.acme.corp, and the work server 106 name is appserver05, client 102 can open a connection to appserver05.wdfacme.corp.

Similarly, if a connection cannot be opened successfully, client 102 can generate a name using the name of the work server 106 and a routing string of message server 104. A routing string can describe the stations of a connection required between two hosts through one or more routers. Client 102 can then open a connection to the work server 106 using this generated name.

If client 102 is still unable to open a connection, client 102 can get the list of work servers 106 in the load-balanced system 100. For example, client 102 can get the list of work servers 106 by calling a function that returns the list of work servers 106 (e.g., the TH_SERVER_LIST function at the message server 104). Client 102 can then match a hostname with the current connection host, get the network address (e.g., Internet Protocol (IP) address) of the current work server 106, and connect to the current work server 106.

After performing the above, client 102 can submit the job for processing. To ensure the job is run on the initially connected work server 106, client 102 can submit job submission code to the work server 106 determined in the first step. This code can perform several steps. First, the job submission code can obtain the name of the host it is running on (e.g., appserver05.wdf.acme.corp). The job submission code may obtain the name of the host it is running on by reading a corresponding system parameter. For example, the job submission code can obtain the name of the host it is running on by executing the following:
CALL ‘C_SAPGPARAM’
ID ‘NAME’ FIELD p_param_myname
ID ‘VALUE’ FIELD env-myname
   As would be appreciated by a person of ordinary skill in the art, the job submission code may obtain the name of the host it is running on using various other mechanisms.

Second, the job submission code can map the obtained name of the host (e.g., “appserver05.wdf.acme.corp”) to a logical name of the work server 106 (e.g., “appserver5”). The job submission code can map the obtained name of the host (e.g., “appserver05.wdf.acme.corp”) to a logical name of the work server 106 using a function. For example, the job submission code can map the obtained name of the host to a logical name of the work server 106 by using the BP_MAP_HOST_TO_BTCSERVER function. The job submission code can map the obtained name of the host (e.g., “appserver05.wdf.acme.corp”) to a logical name of the work server 106 using various other mechanisms as would be appreciated by a person of ordinary skill in the art.

Finally, the job submission code can submit the job for processing using a mechanism (e.g., a job processing function) that executes the job on the target work server 106 returned from the previous step. (e.g., “appserver5”) For example, the job submission code can submit the job for processing using the JOB_CLOSE function with the target server (e.g., “appserver5”) returned from the previous step being passed as a parameter to the JOB_CLOSE function. In other words, instead of the job submission code just including a command such as “submit program,” where “program” represents the job that the work server is to perform, this process can essentially cause the job submission code to execute “submit program on [dynamically determined work server 106]” where [dynamically determined work server 106] represents the name of the work server 106 returned from the previous step (e.g., “appserver5”).

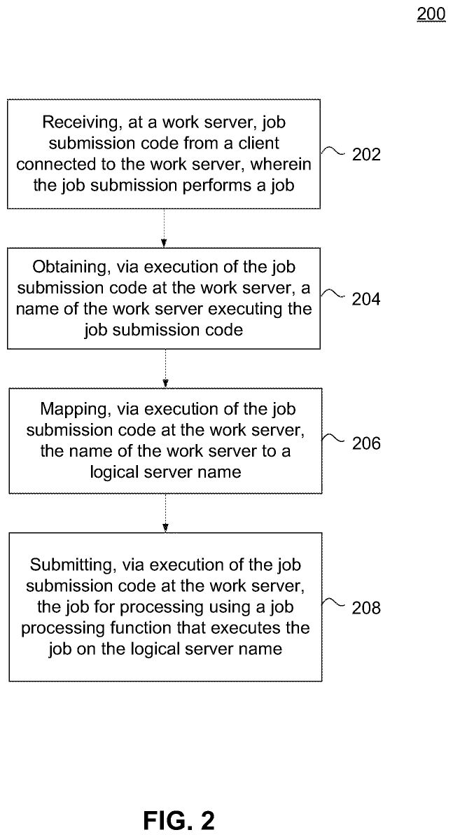

FIG. 2 is a flowchart for a method 200 for performing deterministic execution of jobs (e.g., background jobs) on a load-balanced system, according to an embodiment. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art.

Method 200 shall be described with reference to FIG. 1. However, method 200 is not limited to that example embodiment.

In 202, a work server 106 receives job submission code from client 102, wherein the job submission code performs a job (e.g., a background job) for client 102. Client 102 may be directly connected to the work server 106.

Prior to the work server 106 receiving the job submission code from client 102, client 102 can make a connection to message server 104. When client 102 makes the connection to message server 104, client 102 can determine the name of the particular work server 106 that it ends up being connected to by message server 104. Client 102 may represent its connection to the particular work server 106 using a connection object. Client 102 can determine the name of the work server 106 that it is connected to by reading the name of the work server 106 from attributes of the connection object. For example, client 102 can determine the name of the work server 106 that it is connected to by reading the name of the work server 106 from the RFC_ATTRIBUTES in the connection object. As would be appreciated by a person of ordinary skill in the art, client 102 can determine the name of the work server 106 that it is connected to in various other ways using the connection object.

Client 102 can also determine the name of the work server 106 that it is connected to by calling a remote function at the work server 106. For example, client 102 can determine the name of the work server 106 that it is connected to by calling the RFC_SYSTEM_INFO function at the work server 106. Client 102 may determine the name of the work server 106 that it is connected to by calling the remote function at the work server 106 if it was unable to determine name of the work server 106 using its connection object. Client 102 can determine the name of the work server 106 that it is connected to using various other mechanisms as would be appreciated by a person of ordinary skill in the art.

Once client 102 determines the name of the work server 106 (e.g., possibly prepended with a routing string), client 102 can check if a new connection can be directly opened to the work server 106. If a connection cannot be opened successfully, client 102 can generate a name using the name of the work server 106 and the FQDN of message server 104. For example, client 102 can append a domain name portion of the FQDN of message server 104 to the name of the work server 106. Client 102 can then open a connection to the work server 106 using the generated name. For example, if the FQDN of message server 104 is acmems01.wdf.acme.corp, and the work server 106 name is appserver05, client 102 can open a connection to appserver05.wdfacme.corp.

Similarly, if a connection cannot be opened successfully, client 102 can generate a name using the name of the work server 106 and a routing string of message server 104. A routing string can describe the stations of a connection required between two hosts through one or more routers. Client 102 can then open a connection to the work server 106 using this generated name.

If client 102 is still unable to open a connection, client 102 can get the list of work servers 106 in the load-balanced system 100. Message server 104 may maintain the list of work servers 106 in the load-balanced system 100. Client 102 can get the list of work servers 106 by calling a function that returns the list of work servers 106 (e.g., the TH_SERVER_LIST function at the message server 104). Client 102 can then match a hostname with the current connection host, get the network address (e.g., IP address) of the work server 106, and connect to the work server 106.

The work server 106 can execute the job submission code from client 102. To ensure the job is run on the work server 106, the code may perform several steps.

In 204, the work server 106, via execution of the job submission code, obtains the name of the host (e.g., the work server 106) it is running on (e.g., appserver05.wdfacme.corp). The job submission code may obtain the name of the host (e.g., the work server 106) it is running on by reading a corresponding system parameter. For example, the job submission code can obtain the name of the host (e.g., the work server 106) it is running on by executing the following:
CALL ‘C_SAPGPARAM’
ID ‘NAME’ FIELD p_param_myname
ID ‘VALUE’ FIELD env-myname
   As would be appreciated by a person of ordinary skill in the art, the job submission code may obtain the name of the host (e.g., work server 106) it is running on using various other mechanisms.

In 206, the work server 106, via execution of the job submission code, maps the obtained name of the host (e.g., “appserver05.wdf.acme.corp”) to a logical name of the work server 106 (e.g., “appserver5”). The job submission code can map the obtained name of the host (e.g., “appserver05.wdf.acme.corp”) to a logical name of the work server 106 using a function. For example, the job submission code can map the obtained name of the host to a logical name of the work server 106 by using the BP_MAP_HOST_TO_BTCSERVER function. The job submission code can map the obtained name of the host (e.g., “appserver05.wdf.acme.corp”) to a logical name of the work server 106 using various other mechanisms as would be appreciated by a person of ordinary skill in the art.

In 208, the work server 106, via execution of the job submission code, submits the job for processing using a mechanism (e.g., a job processing function) that executes the job on the work server 106 obtained by the job submission code (e.g., “appserver5”). For example, the job submission code can submit the job for processing using the JOB_CLOSE function with the target server (e.g., “appserver5”) obtained by the job submission code being passed as a parameter to the JOB_CLOSE function. In other words, instead of the job submission code just including a command such as “submit program,” where “program” represents the job that a work server 106 is to perform, this process can essentially cause the job submission code to execute “submit program on [dynamically determined work server 106]” where [dynamically determined work server 106] represents the name of the work server 106 obtained by the job submission code (e.g., “appserver5”).

After executing the job submission code, the work server 106 may receive a request to check a status of the job from client 102. In response to receiving the request to check the status of the background job, the work server 106 can determine the status of the job. The work server 106 can then transmit the status of the job to client 102 (e.g., over the network).

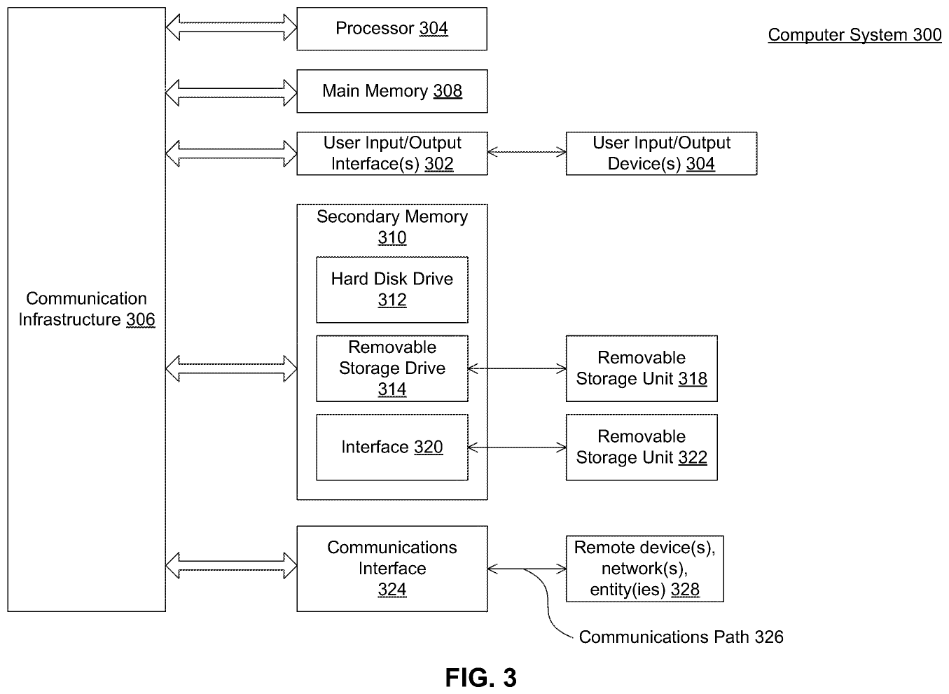

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method for performing deterministic execution of background jobs in a load-balanced system, comprising:
receiving, at a work server in the load-balanced system, job submission code from a client connected to the work server, wherein the job submission code performs a background job for the client; and
executing, at the work server, the job submission code, wherein the execution of the job submission code:
obtains a name of the work server executing the job submission code;
maps the name of the work server to a logical server name; and
submits the background job for background processing using a job processing function that executes the background job on the logical server name.

2. The computer implemented method of claim 1, further comprising:
receiving, at the work server, a request from the client to execute a function that determines the name of the work server;
executing, at the work server, the function that determines the name of the work server; and
in response to executing the function, transmitting, from the work server, the name of the work server to the client;
wherein the client directly connects to the work server using the name of the work server.

3. The computer implemented method of claim 1, wherein the client directly connects to the work server using the name of the work server and a routing string.

4. The computer implemented method of claim 1, wherein the client directly connects to the work server using the name of the work server and a fully qualified domain name of a message server connected to the work server.

5. The computer implemented method of claim 1, wherein the client directly connects to the work server based on a list of work servers maintained by a message server that is connected to the work server.

6. The computer implemented method of claim 1, wherein the execution of the job submission code comprises mapping the name of the work server to the logical server name using a function of the work server.

7. The computer implemented method of claim 1, further comprising:
receiving, at the work server, a request to check a status of the background job from the client;
in response to receiving the request to check the status of the background job, determining, at the work server, the status of the background job; and
transmitting, from the work server, the status of the background job to the client.

8. A work server for performing deterministic execution of background jobs in a load-balanced system, comprising:
a memory; and
at least one processor coupled to the memory and configured to:
receive job submission code from a client connected to the work server, wherein the job submission code performs a background job for the client; and
execute the job submission code, wherein the execution of the job submission code:
obtains a name of the work server executing the job submission code;
maps the name of the work server to a logical server name; and
submits the background job for background processing using a job processing function that executes the background job on the logical server name.

9. The work server of claim 8, wherein the at least one processor is further configured to:
receive a request from the client to execute a function that determines the name of the work server;
execute the function that determines the name of the work server; and
in response to executing the function, transmitting the name of the work server to the client;
wherein the client directly connects to the work server using the name of the work server.

10. The work server of claim 8, wherein the client directly connects to the work server using the name of the work server and a routing string.

11. The work server of claim 8, wherein the client directly connects to the work server using the name of the work server and a fully qualified domain name of a message server connected to the work server.

12. The work server of claim 8, wherein the client directly connects to the work server based on a list of work servers maintained by a message server that is connected to the work server.

13. The work server of claim 8, wherein the execution of the job submission code comprises mapping the name of the work server to the logical server name using a function of the work server.

14. The work server of claim 8, wherein the at least one processor is further configured to:
receive a request to check a status of the background job from the client;
in response to receiving the request to check the status of the background job, determine the status of the background job; and
transmit the status of the background job to the client.

15. A non-transitory computer-readable medium having instructions stored thereon that, when executed by at least one computing device, cause the at least one computing device to perform operations comprising:
receiving, at the at least one computing device in a load-balanced system, job submission code from a client connected to the at least one computing device, wherein the job submission code performs a background job for the client; and
executing, at the at least one computing device, the job submission code, wherein the execution of the job submission code:
obtains a name of the at least one computing device executing the job submission code;
maps the name of the at least one computing device to a logical server name; and
submits the background job for background processing using a job processing function that executes the background job on the logical server name.

16. The non-transitory computer-readable medium of claim 15, wherein the operations further comprise:
receiving, at the at least one computing device, a request from the client to execute a function that determines the name of the at least one computing device;
executing, at the at least one computing device, the function that determines the name of the at least one computing device; and
in response to executing the function, transmitting, from the at least one computing device, the name of the at least one computing device to the client;
wherein the client directly connects to the at least one computing device using the name of the at least one computing device.

17. The non-transitory computer-readable medium of claim 15, wherein the client directly connects to the at least one computing device using the name of the at least one computing device and a routing string.

18. The non-transitory computer-readable medium of claim 15, wherein the client directly connects to the at least one computing device using the name of the at least one computing device and a fully qualified domain name of a message server connected to the at least one computing device.

19. The non-transitory computer-readable medium of claim 15, wherein the client directly connects to the at least one computing device based on a list of computing devices maintained by a message server that is connected to the at least one computing device.

20. The non-transitory computer-readable medium of claim 15, wherein the execution of the job submission code comprises mapping the name of the at least one computing device to the logical server name using a function of the at least one computing device.
